(19) United States
(12) Patent Application Publication
(10) Pub. No.: US 2005/0204205 A1
(43) Pub. Date: Sep. 15, 2005

(54) Methodology, system, and computer readable medium for detecting operating system exploitations

(76) Inventors: Sandra E. Ring, Alexandria, VA (US); Eric B. Cole, Leesburg, VA (US)

Correspondence Address: TIMOTHY J MARTIN, PC, 9250 W 5TH AVENUE, SUITE 200, LAKEWOOD, CO, 80226, US

(21) Appl. No.: 10/789,413

(22) Filed: Feb. 27, 2004

Related U.S. Application Data
(62) Division of application No. 10/789,460, filed on Feb. 26, 2004.

(51) Int. Cl. G06F 11/00

(52) U.S. Cl. 714/47

(57) ABSTRACT

A system, computerized method and computer-readable medium are provided for the detection of an operating system exploitation, such as a rootkit install. The operating system is monitored to ascertain an occurrence of anomalous activity resulting from operating system behavior which deviates from any one of a set of pre-determined operating system parameters. Each parameter corresponds to a dynamic characteristic associated with an unexploited operating system. Output can then be generated to indicate any anomalous activity that is ascertained. The computer-readable medium may comprise a loadable kernel module for detecting hidden patches, processes, files or other kernel modules.

### BACKGROUND OF THE INVENTION

The present invention generally concerns the detection of activity and data characteristic of a computer system exploitation, such as surreptitious rootkit installations. To this end, the invention particularly pertains to the fields of intrusion detection.

The increase in occurrence and complexity of operating system (OS) compromises makes manual analysis and detection difficult and time consuming. To make matters worse, most reasonably functioning detection methods are not capable of discovering surreptitious exploits, such as new rootkit installations, because they are designed to statically search the operating system for previously derived signatures only. More robust techniques aimed at identifying unknown rootkits typically require installation previous to the attack and periodic offline static analysis. Prior installation is often not practical and many, if not most, production systems cannot accept the tremendous performance impact of being frequently taken offline.

The integration of biological analogies into computer paradigms is not new and has been a tremendous source of inspiration and ingenuity for well over a decade. Perhaps the most notable of the analogies occurred in 1986 when Len Adleman coined the phrase “computer virus” while advising Fred Cohen on his PhD thesis on self-replicating software. The association between the biological immune system and fighting computer viruses was made by Jeffrey Kephart and was generalized to all aspects of computer security by Forrest, Perelson, Allen, and Cheruki in 1994. Although the biological immune system is far from perfect it is still well beyond the sophistication of current computer security approaches. Much can be learned by analyzing the strengths and weaknesses of what thousands of years of evolution have produced.

The continual increase of exploitable software on computer networks has led to an epidemic of malicious activity by hackers and an especially hard challenge for computer security professionals. One of the more difficult and still unsolved problems in computer security involves the detection of exploitation and compromise of the operating system itself. Operating system compromises are particularly problematic because they corrupt the integrity of the very tools that administrators rely on for intruder detection. In the biological world this is analogous to auto-immune diseases such as AIDS. These attacks are distinguished by the installation of rootkits.

A rootkit is a common name for a collection of software tools that provides an intruder with concealed access to an exploited computer. Contrary to the implication by their name, rootkits are not used to gain root access. Instead they are responsible for providing the intruder with such capabilities as (1) hiding processes, (2) hiding network connections, and (3) hiding files. Like auto-immune diseases, rootkits deceive the operating system into recognizing the foreign intruder's behavior as “self” instead of a hostile pathogen.

Rootkits are generally classified into two categories—application level rootkits and kernel modifications. To the user, the behavior and properties of both application level and kernel level rootkits are identical; the only real difference between the two is their implementation. Application rootkits are commonly referred to as Trojans because they operate by placing a “Trojan Horse” within a trusted application (i.e., ps, ls, netstat, etc.) on the exploited computer. Popular examples of application rootkits include T0M and Lrk5. Many application level rootkits operate by physically replacing or modifying files on the hard drive of the target computer. This type of examination can be easily automated by comparing the checksums of the executables on the hard drive to known values of legitimate copies. Tripwire is a good example of a utility that does this.

Kernel rootkits are identical capability wise, but function quite differently. Kernel level rootkits consist of programs capable of directly modifying the running kernel itself. They are much more powerful and difficult to detect because they can subvert any application level program, without physically “trojaning” it, by corrupting the underlying kernel functions. Instead of trojaning programs on disk, kernel rootkits generally modify the kernel directly in memory as it is running. Intruders will often install them and then securely delete the file from the disk using a utility such as fwipe or overwrite. This can make detection exceedingly difficult because there is no physical file left on the disk. Popular examples of kernel level rootkits such as SuckIT and Adore can sometimes be identified using the utility Chkrootkit. However, this method is signature based and is only able to identify a rootkit that it has been specifically programmed to detect. In addition, utilities such as this do not have the functionality to collect rootkits or protect evidence on the hard drive from accidental influence. Moreover, file based detection methods such as Tripwire are not effective against kernel level rootkits.

Rootkits are often used in conjunction with sophisticated command and control programs frequently referred to as “backdoors.” A backdoor is the intruder's secret entrance into the computer system that is usually hidden from the administrator by the rootkit. Backdoors can be implemented via simple TCP/UDP/ICMP port listeners or via incorporation of complex stealthy trigger packet mechanisms. Popular examples include netcat, icmp-shell, udp-backdoor, and ddb-ste. In addition to hiding the binary itself, rootkits are typically capable of hiding the backdoor's process and network connections as well.

Known rootkit detection methods are essentially discrete algorithms of anomaly identification. Models are created and any deviation from them indicates an anomaly. Models are either based on the set of all anomalous instances (negative detection) or all allowed behavior (positive detection). Much debate has taken place in the past over the benefit of positive verses negative detection methods, and each approach has enjoyed reasonable success.

Negative detection models operate by maintaining a set of all anomalous (non-self) behavior. The primary benefit to negative detection is its ability to function much like the biological immune system in its deployment of “specialized” sensors. However, it lacks the ability to “discover” new attack methodologies. Signature based models, such as Chkrootkit noted above, are implementations of negative detection. Chkrootkit maintains a collection of signatures for all known rootkits (application and kernel). This is very similar to mechanisms employed by popular virus detectors. Although successful against them, negative detection schemes are only effective against “known” rootkit signatures, and thus have inherent limitations. This means that these systems are incapable of detecting new rootkits that have not yet had signatures distributed. Also, if an existing rootkit is modified slightly to adjust its signature it will no longer be detected by these programs. Chkrootkit is only one rootkit detection application having such a deficiency, and users of this type of system must continually acquire new signatures to defend against the latest rootkits, which increases administrator workload rather than reducing it. Because computer system exploits evolve rapidly, this solution will never be complete and users of negative detection models will always be “chasing” to catch up with offensive technologies.

Positive detection models operate by maintaining a set of all acceptable (self) behavior. The primary benefit to positive detection is that it allows for a smaller subset of data to be stored and compared; however accumulation of this data must take place prior to an attack for integrity assurance. One category of positive detection is the implementation of change detection. A popular example of a change detection algorithm is Tripwire, referred to above, which operates by generating a mathematical baseline using a cryptographic hash of files within the computer system immediately following installation (i.e., while it is still “trusted”). It assumes that the initial install is not infected. Tripwire maintains a collection of what it considers to be self, and anything that deviates or changes is anomalous. Periodically the computer system is examined and compared to the initial baseline. Although this method is robust because, unlike negative detection, it is able to “discover” new rootkits, it is often unrealistic. Few system administrators have the luxury of being present to develop the baseline when the computer system is first installed. Most administer systems that are already loaded, and therefore are not able to create a trusted baseline to start with. Moreover, this approach is incapable of detecting rootkits “after the fact” if a baseline or clean system backup was not previously developed. In an attempt to solve this limitation, some change detection systems such as Tripwire provide access to a database of trusted signatures for common operating system files. Unfortunately this is only a small subset of the files on the entire system.

Another drawback with static change analysis is that the baseline for the system is continually evolving. Patches and new software are continually being added and removed from the system. These methods can only be run against files that are not supposed to change. Instead of reducing the amount of workload for the administrator, the constant requirement to re-baseline with every modification dramatically increases it. Furthermore, current implementations of these techniques require that the system be taken offline for inspection when detecting the presence of kernel rootkits. Therefore, a need remains to develop a more robust approach to detecting operating system exploits in general, and surreptitious rootkit installs in particular, which does not suffer from the drawbacks associated with known positive and negative detection models.

### BRIEF SUMMARY OF THE INVENTION

A system for detecting exploitation of an operating system, which is of a type that renders a computer insecure, comprises a storage device, an output device and a processor. The processor is programmed to monitor the operating system to ascertain an occurrence of anomalous activity resulting from operating system behavior, which deviates from any one of a set of predetermined operating system parameters. Each of the predetermined operating system parameters corresponds to a dynamic characteristic associated with an unexploited operating system. The processor is additionally programmed to generate output on the output device which is indicative of any anomalous activity that is ascertained. The present invention is advantageously suited for detecting exploitations such as hidden kernel module(s), hidden system call table patch(es), hidden process(es), hidden file(s) and hidden port listener(s).

The set of predetermined operating system parameters may be selected from (1) a first parameter corresponding to a requirement that all calls within the kernel's system call table reference an address that is within the kernel's memory range; (2) a second parameter corresponding to a requirement that each address range between adjacent modules in the linked list of modules be devoid of any active memory pages; (3) a third parameter corresponding to a requirement that a kernel space view of each running process correspond to that in user space; (4) a fourth parameter corresponding to a requirement that any unused port on the computer have the capability of being bound to; and (5) is a fifth parameter corresponding to a requirement that a kernel space view that each existing file correspond to that in user space. For purposes of the first requirement, where the operating systems is Unix-based, the kernel memory range is between a starting address of an 0xc0100000 and an ending address which is determined with reference to either a global variable or an offset calculation based on a global variable. The processor is, thus, programmed to ascertain the occurrence of anomalous activity upon detecting operating system behavior which does not abide by any one of these parameters.

A computerized method is also provided for detecting exploitation of a computer operating system. One embodiment of the method comprising establishment of a set of operating system parameters, such as those above, monitoring of the operating system to ascertain an occurrence of any anomalous activity resulting from behavior which deviates from any parameter, and generation of output indicative of a detected exploitation when anomalous activity is ascertained. Another embodiment of the computerized method is particularly capable of detecting an exploitation irrespective of whether the exploitation is signature based, and without a prior baseline view of the operating system.

Finally, the present invention provides various embodiments for a computer-readable medium. One embodiment detects rootkit installations on a computer running an operating system, such as one which is Unix-based, and comprises a loadable kernel module having executable instructions for performing a method which comprises monitoring the operating system in a manner such as described above. In another embodiment, the computer readable medium particularly detects rootkit exploitation on a Linux operating system. This embodiment also preferably incorporates a loadable kernel module, with its executable instructions for performing a method which entails (1) analyzing the operating system's memory to detect in existence of any hidden kernel module, (2) analyzing its system call table to detect an existence of any hidden patch thereto, (3) analyzing the computer to detect any hidden process; and (4) analyzing the computer to detect any hidden file. Analysis of the system call table may be performed by initially obtaining an unbiased address for the table, and thereafter searching each call within the table to ascertain if it references and address outside of the kernel's dynamic memory range. Analysis for any hidden process and for any hidden files is preferably accomplished by comparing respective kernel space in user space use to ascertain if any discrepancies exists therebetween.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 represents a high level diagrammatic view of an exemplary security software product which incorporates the exploit detection component of the present invention;

FIG. 2 represents a high level flow chart for computer software which incorporates exploitation detection;

FIG. 3 is a high level flow chart diagrammatically illustrating the principle features for the exploitation detection component of the invention;

FIG. 4 is a high level flow chart for computer software which implements the functions of the exploitation detection component's kernel module;

FIG. 5 is a high level diagrammatic view, similar to FIG. 1, for illustrating the integration of the detection component's various detection models into an overall software security system;

FIG. 6(a) is a prior art diagrammatic view illustrating an unaltered linked list of kernel modules;

FIG. 6(b) is a prior art diagrammatic view illustrating the kernel modules of FIG. 6(a) after one of the modules has been removed from the linked list using a conventional hiding technique;

FIG. 7 is a block diagram representing the physical memory region of an exploited computer which has a plurality of loadable kernel modules, one of which has been hidden;

FIG. 8 represents a flow chart for computer software which implements the functions of the hidden module detection routine that is associated with the exploitation detection component of the present invention;

FIG. 9 is a diagrammatic view for illustrating the interaction in the Linux OS between user space applications and the kernel;

FIGS. 10(a)-10(d) collectively comprise a flow chart for computer software which implements the functions of the exploitation detection component's routine for detecting hidden system call patches;

FIG. 11 is tabulated view which illustrates, for representative purposes, the ranges of address which were derived when the hidden system call patches detection routine of FIG. 10 was applied to a computer system exploited by the rootkit Adore v0.42;

FIG. 12 is a functional block diagram for representing the hidden process detection routine associated with the exploitation component of the present invention;

FIG. 13 represents a flow chart for computer software which implements the functions of the hidden process detection routine;

FIG. 14 represents a flow chart for computer software which implements the functions of the process ID checking subroutine of FIG. 13;

FIG. 15 is a functional block diagram for representing the hidden file detection routine associated with the exploitation component of the present invention;

FIG. 16 represents a flow chart for computer software which implements the functions of the hidden file detection routine;

FIG. 17 represents a flow chart for computer software which implements the file checker script associated with the exploitation detection component of the present invention;

FIG. 18 is a functional block diagram for representing the port checker script associated with the exploitation component of the present invention;

FIG. 19 represents a flow chart for computer software which implements the port checker script;

FIGS. 20(a)-20(d) are each representative output results obtained when the exploitation detection component described in FIGS. 3-19 was tested against an unexploited system (FIG. 20(a)), as well a system exploited with a user level rootkit (FIG. 20(b)) and different types of kernel level rootkits (FIGS. 20(c) & (d));

### DETAILED DESCRIPTION OF THE INVENTION

### I. Introduction

This invention preferably provides a software component, referred to herein as an exploitation detection component or module, which may be used as part of a detection system, a computer-readable medium, or a computerized methodology. This component was first introduced as part of a suite of components for handling operating system exploitations in our commonly owned, parent application Ser. No. ______ filed on Feb. 26, 2004, and entitled “Methodology, System, Computer Readable Medium, And Product Providing A Security Software Suite For Handling Operating System Exploitations”, which is incorporated by reference.

The exploitation detection component operates based on immunology principles to conduct the discovery of compromises such as rootkit installations. As discussed in the Background section, selecting either positive or negative detection entails a choice between the limitation of requiring a baseline prior to compromise, or being unable to discover new exploits such as rootkits. Rather than relying on static file and memory signature analysis like other systems, this model is more versatile. It senses anomalous operating system behavior when activity in the operating system deviates, that is fails to adhere to, a set of predetermined parameters or premises which dynamically characterize an unexploited operating system of the same type. The set of parameters, often interchangeably referred to herein as “laws” or “premises”, may be a single parameter or a plurality of them. Thus, the invention demonstrates a hybrid approach that is capable of discovering both known and unknown rootkits on production systems without having to take them offline, and without the use of previously derived baselines or signatures.

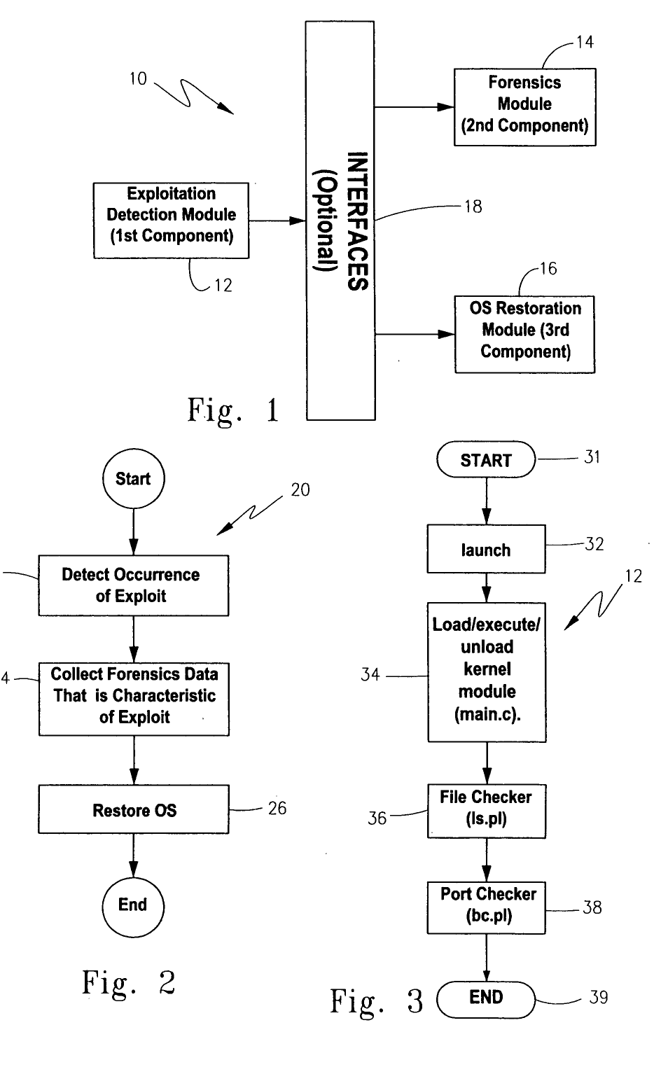

The exploitation detection component preferably relies on generalized, positive detection of adherence to defined “premises” or “laws” of operating system nature, and incorporates negative detection sensors based on need. As discussed in the parent application, and as illustrated in FIG. 1, the exploitation detection component 12 may be part of a product or system 10 whereby it interfaces with other components 14 & 16 which, respectively, collect forensics evidence and restore a computer system to a pre-compromise condition. As also shown in FIG. 2, the functionalities 22 of the exploitation detection component may be used as part of a overall methodology 20 which also includes the functionalities 24 & 26 that are respectively associated with forensics data collection and OS restoration.

Because the invention is designed to operate while the computer is functioning online as a production server, performance impact is minimal. Moreover, the invention can be ported to virtually any operating system platform and has been proven through implementation on Linux. An explanation of the Linux operating system is beyond the scope of this document and the reader is assumed to be either conversant with its kernel architecture or to have access to conventional textbooks on the subject, such as Linux Kernel Programming, by M. Beck, H. Böhme, M. Dziadzka, U. Kunitz, R. Magnus, C. Schröter, and D. Verworner., 3^{rd} ed., Addison-Wesley (2002), which is hereby incorporated by reference in its entirety for background information.

In the following detailed description, reference is made to the accompanying drawings which form a part hereof, and in which is shown by way of illustrations specific embodiments for practicing the invention. The leading digit(s) of the reference numbers in the figures usually correlate to the figure number, with the exception that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Various terms are used throughout the description and the claims which should have conventional meanings to those with a pertinent understanding of computer operating systems, namely Linux, and software programming. Other terms will perhaps be more familiar to those conversant in the areas of intrusion detection. While the description to follow may entail terminology which is perhaps tailored to certain OS platforms or programming environments, the ordinarily skilled artisan will appreciate that such terminology is employed in a descriptive sense and not a limiting sense. Where a confined meaning of a term is intended, it will be set forth or otherwise apparent from the disclosure.

In one of its forms, the present invention provides a system for detecting an operating system exploitation that is implemented on a computer which typically comprises a random access memory (RAM), a read only memory (ROM), and a central processing unit (CPU). One or more storage device(s) may also be provided. The computer typically also includes an input device such as a keyboard, a display device such as a monitor, and a pointing device such as a mouse. The storage device may be a large-capacity permanent storage such as a hard disk drive, or a removable storage device, such as a floppy disk drive, a CD-ROM drive, a DVD-ROM drive, flash memory, a magnetic tape medium, or the like. However, the present invention should not be unduly limited as to the type of computer on which it runs, and it should be readily understood that the present invention indeed contemplates use in conjunction with any appropriate information processing device, such as a general-purpose PC, a PDA, network device or the like, which has the minimum architecture needed to accommodate the functionality of the invention. Moreover, the computer-readable medium which contains executable instructions for performing the methodologies discussed herein can be a variety of different types of media, such as the removable storage devices noted above, whereby the software can be stored in an executable form on the computer system.

The source code for the software was developed in C on an x86 machine running the Red Hat Linux 8 operating system (OS), kernel 2.4.18. The standard GNU C compiler was used for converting the high level C programming language into machine code, and Perl scripts where also employed to handle various administrative system functions. However, it is believed the software program could be readily adapted for use with other types of Unix platforms such as Solaris®, BSD and the like, as well as non-Unix platforms such as Windows® or MS-DOS®. Further, the programming could be developed using several widely available programming languages with the software component coded as subroutines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventors should not be interpreted to limit the environment of the present invention.

A product embodying the present invention may be distributed in known manners, such as on a computer-readable medium or over an appropriate communications interface so that it can be installed on the user's computer. Furthermore, alternate embodiments which implement the invention in hardware, firmware or a combination of both hardware and firmware, as well as distributing the software component and/or the data in a different fashion will be apparent to those skilled in the art. It should, thus, be understood that the description to follow is intended to be illustrative and not restrictive, and that many other embodiments will be apparent to those of skill in the art upon reviewing the description.

The invention has been employed by the inventors utilizing the development tools discussed above, with the software component being coded as a separate module which is compiled and dynamically linked and unlinked to the Linux kernel on demand at runtime through invocation of the init_module( ) and cleanup_module( ) system calls. As stated above, Perl scripts are used to handle some of the administrative tasks associated with execution, as well as some of the output results.

The ordinarily skilled artisan will recognize that the concepts of the present invention are virtually platform independent. Further, it is specifically contemplated that the functionalities described herein can be implemented in a variety of manners, such as through direct inclusion in the kernel code itself, as opposed to one or more modules which can be linked to (and unlinked from) the kernel at runtime. Thus, the reader will see that the more encompassing term “component” or “software component” are sometimes used interchangeably with the term “module” to refer to any appropriate implementation of programs, processes, modules, scripts, functions, algorithms, etc. for accomplishing these capabilities. Furthermore, the reader will see that terms such, “program”, “algorithm”, “function”, “routine” and “subroutine” are used throughout the document to refer to the various processes associated with the programming architecture. For clarity of explanation, attempts have been made to use them in a consistent hierarchical fashion based on the exemplary programming structure. However, any interchangeable use of these terms, should not be misconstrued as limiting since that is not the intent.

### II. Exploitation Detection Component

A software component is in the form of an exploitation detection module 12 which is preferably responsible for detecting a set of exploits (i.e. one or more), including hidden kernel modules, operating system patches (such as to the system call table), and hidden processes. This module also generates a “trusted” file listing for comparison purposes. The exploitation detection module is discussed in detail below with reference to FIGS. 3-20(d), and it primarily focuses on protecting the most sensitive aspect of the computer, its operating system. In particular it presents an approach based on immunology to detect OS exploits, such rootkits and their hidden backdoors. Unlike current rootkit detection systems, this model is not signature based and is therefore not restricted to identification of only “known” rootkits. In addition this component is effective without needing a prior baseline of the operating system for comparison. Furthermore, this component is capable of interfacing with the other modules discussed below for conducting automated forensics and self-healing remediation as well.

Differentiating self from non-self ca be a critical aspect for success in anomaly detection. Rather than relying on pre-compromise static training (machine learning) like other research, one can instead generalize current operating system behaviors in such a way that expectations are based on a set of pre-determined operating system parameters (referred to herein as fundamental “laws” or “premises”), each of which corresponds to a dynamic characteristic of an unexploited operating system. Unlike errors introduced during machine learning, changes in behavior based on operating premises lead to true anomalies. Therefore, false positives are limited to race conditions and other implementation errors. In addition, false positives are absent because of the conservative nature of the laws.

Through the use of independent, but complementary sensors, the exploitation detection component identifies erroneous results by unambiguously distinguishing self from non-self, even though the behaviors of each may change over time. Rather than selecting one single method (i.e. positive or negative detection) for this model, the exploitation detection component leverages the complimentary strengths of both to create a hybrid design. Similar to the biological immune system, generalization takes place to minimize false positives and redundancy is relied on for success.

This component begins by observing adherence to the following fundamental premises, using positive detection. Once a deviation has been identified, the component implements negative detection sensors to identify occurrences of pathogens related to the specific anomaly:
Premise 1: All kernel calls should only reference addresses located within normal kernel memory.
Premise 2: Memory pages in use indicate a presence of functionality or data.
Premise 3: A process visible in kernel space should be visible in user space.
Premise 4: All unused ports can be bound to.
Premise 5: Persistent files must be present on the file system media.
   Thus, an operating system can be monitored to ascertain if its behavior adheres to these “premises” or predetermined operating system parameters. As such, a deviation from any one of these requirements indicates an occurrence of anomalous activity, such as the presence of either an application or kernel level exploitation that is attempting to modify the integrity of the operating system by altering its behavior. The exploitation detection component is preferably composed of a loadable kernel module (LKM) and accompanying scripts. It does not need to be installed prior to operating system compromise, but installation requires root or administrator privileges. To preserve the original file system following a compromise, the module and installation scripts can be executed off of removable media or remotely across a network.

Initial reference is made to FIG. 3 which shows a high-level flowchart for diagrammatically illustrating exploitation detection component 12. When the exploitation detection component 12 is started at 31, a prototype user interface 32 is launched. This is a “shell” script program in “/bin/sh”, and is responsible for starting the three pieces of exploitation detection component 12, namely, exploitation detection kernel module (main.c) 34, file checker program (Is.pl) 36 and port checker program (bc.pl) 38. The kernel module 34 is loaded/executed and then unloaded. This is the primary component of the exploitation detection component 12 and is responsible for detecting hidden kernel modules, kernel system call table patches, hidden processes, and for generating a “trusted” listing of file that is later compared by file checker 36. File checker 36 may also be a script that is programmed in Perl, and it is responsible for verifying that each file listed in the “trusted” listing generated by kernel module 34 is visible in user space. Anything not visible in user space is reported as hidden. Finally, port checker 38 is also executed as a Perl script. It attempts to bind to each port on the system. Any port which cannot be bound to, and which is not listed under netstat is reported as hidden. After each of the above programs have executed, the exploitation detection component ends at 39.

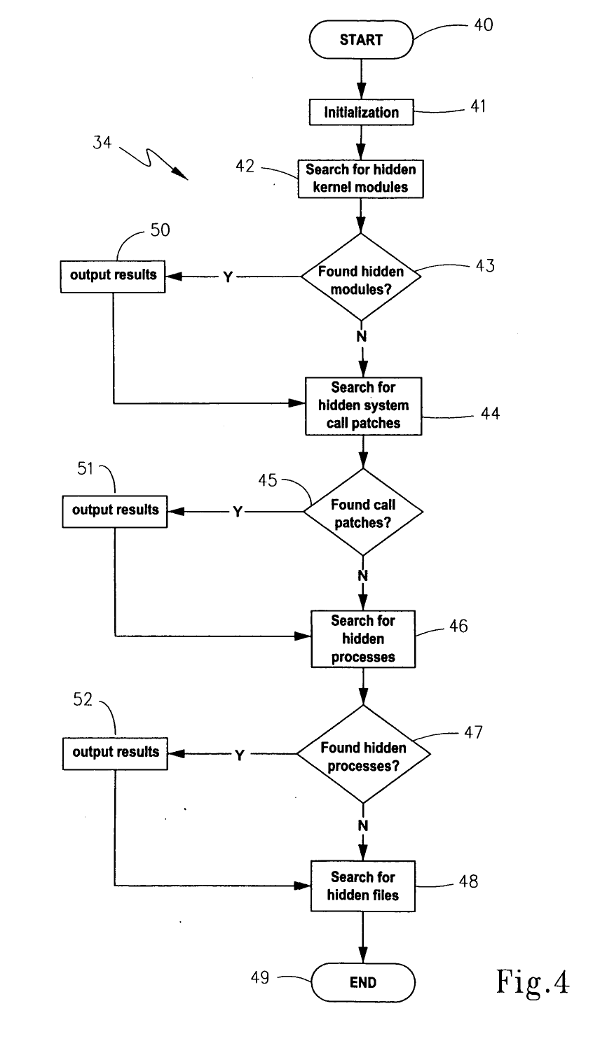

The program flow for kernel module 34 is shown in FIG. 4. Following start 40, an initialization 41 takes place in order to, among other things, initialize variables and file descriptors for output results. A global header file is included which, itself, incorporates other appropriate headers through #include statements and appropriate parameters through #define statements, all as known in the art. A global file descriptor is also created for the output summary results, as well as a reusable buffer, as needed. Modifications to the file descriptor only take place in _init and the buffer is used in order by functions called in _init so there is no need to worry about making access to these thread safe. This is needed because static buffer space is extremely limited in the virtual memory portion of the kernel. One alternative is to kmalloc and free around each use of a buffer, but this creates efficiency issues. As for other housekeeping matters, initialization 41 also entails the establishment of variable parameters that get passed in from user space, appropriate module parameter declarations, function prototype declarations, external prototype declarations (if used), and establishment of an output file wrapper. This is a straightforward variable argument wrapper for sending the results to an output file. It uses a global pointer that is initially opened by _init and closed with _fini. In order to properly access the file system, the program switches back and forth between KERNEL_DS and the current (user) fs state before each write. It should be appreciated that the above initialization, as well as other aspects of the programming architecture described herein for this module, is dictated in part by the current proof of concept, working prototype status of the invention, and is not to be construed in any way as limiting. Indeed, other renditions such as commercially distributable applications would likely be tailored differently based on need, while still embodying the spirit and scope of the present invention.

Following initialization 31, a function is called to search at 42 the kernel's memory space for hidden kernel modules. If modules are found at 43, then appropriate output results 50 are generated whereby names and addresses of any hidden modules are stored in the output file. Whether or not hidden modules are found at 43, the program then proceeds at 44 to search for hidden system call patches within the kernel's memory. If any system call patches are found, their names and addresses are output at 51. Again, whether or not hidden patches are located, the program then proceeds to search for hidden processes at 46. If needed, appropriate output results are provided at 53, which preferably include a least the name and ID of any hidden processes. Finally, the kernel module 34 searches at 48 for hidden files 48 whereby a trusted list of all files visible by the kernel is generated. This trusted listing is subsequently compared to the listing of files made from user space (File checker 38 in FIG. 3). The program flow for kernel module 34 then ends at 49.

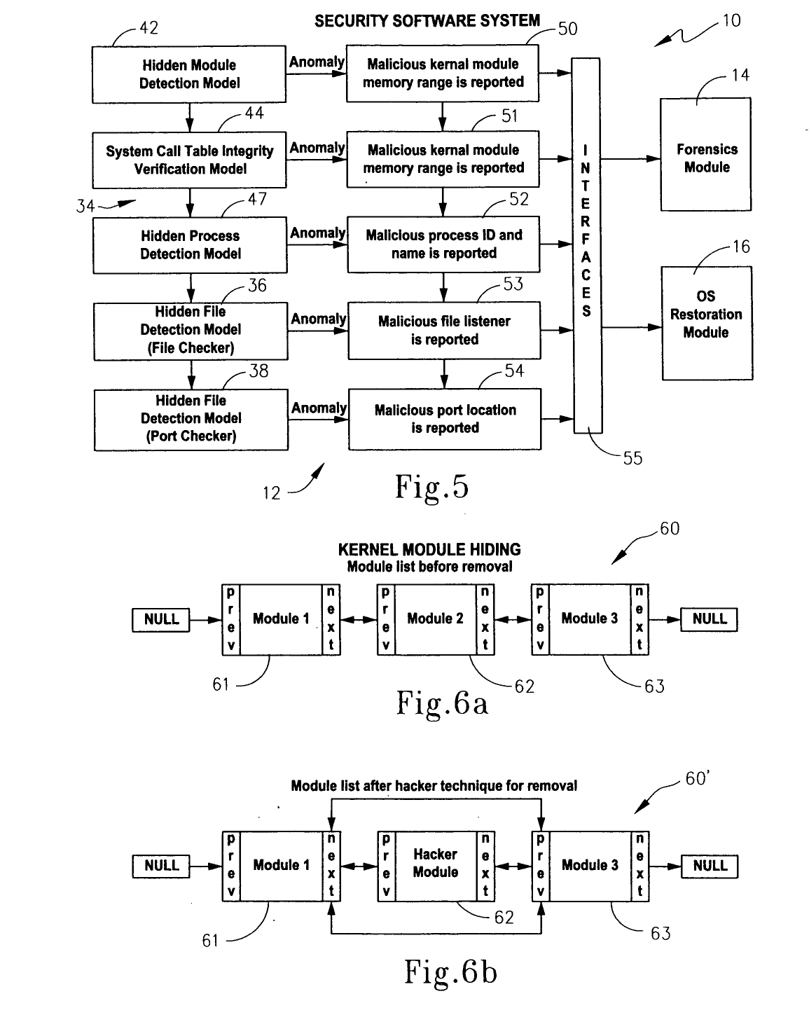

With an understanding of FIG. 4, the integration of the exploitation detection component's functionality into overall security software product/system 10, such as discussed in the parent application, is seen with reference to FIG. 5. Each of the various detection models associated with exploitation detection component 12 preferably reports appropriate output results upon anomaly detection. Thus, if an anomaly is detected by hidden module detection model 42, the malicious kernel module memory range is reported which corresponds to the generation of output results 50 in FIG. 4. The same holds true for the system call table integrity verification model 44 and the hidden processes detection model 47 which, respectively, report any anomalies at 51 and 52. Any anomaly determined by hidden file detection model 36 or hidden port detection model 38 are, respectively, reported at 53 and 54. Appropriate interfaces 55 allow the malicious activity to be sent to an appropriate forensics module 14 and/or OS restoration module 16, as desired.

The various functions associated with kernel module 34 in FIG. 4 will now be discussed in greater detail. The first of these corresponds to the search for hidden modules 42 in FIG. 4. As kernel modules are loaded on the operating system they are entered into a linked list located in kernel virtual memory used to allocate space and maintain administrative information for each module. The most common technique for module hiding is to simply remove the entry from the linked list. This is illustrated in FIGS. 6(a) and 6(b). FIG. 6(a) illustrates a conventional module listing 60 prior to exploitation. Here, each module 61-63 is linked by pointers to each predecessor and successor module. FIG. 6(b), though, illustrates what occurs with the linked list when a module has been hidden. In FIG. 6(b), it may be seen that intermediate module 62 of now altered linked list 60′ has now been hidden such that it no longer points to predecessor module 61 or successor module 63. Removing the entry as shown, however, does not alter the execution of the module itself—it simply prevents an administrator from readily locating it. Thus, even though module 62 is unlinked, it remains in the same position in virtual memory because this space is in use by the system and is not de-allocated while the module is loaded. This physical location is a function of the page size, alignment, and size of all previously loaded modules. It is difficult to calculate the size of all previously loaded modules with complete certainty because some of the previous modules may be hidden from view. Rather than limiting analysis to “best guesses”, the system analyzes the space between every linked module.

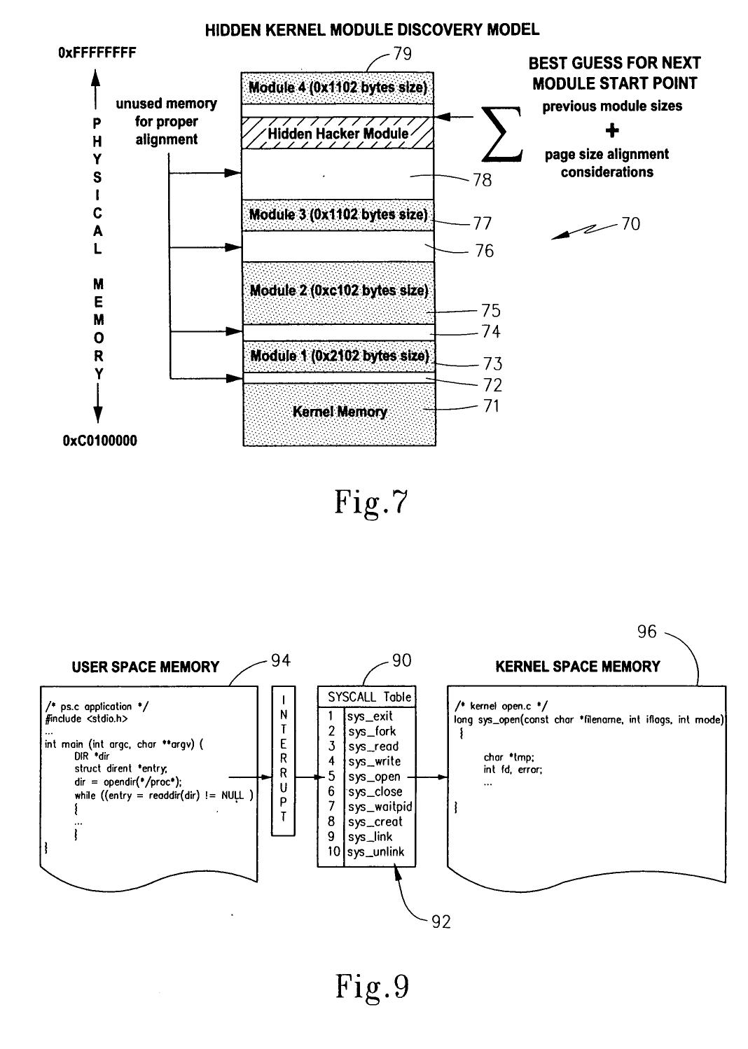

To more fully appreciate this, FIG. 7 illustrates various modules stored within a computer's physical memory 70. More particularly, a lower portion of the physical memory beginning at address 0xC0100000 is occupied by kernel memory 71. FIG. 7 shows a plurality of loadable kernel modules (LKMs) 73, 75, 77 and 79 which have been appended to the kernel memory as a stacked array. Each LKM occupies an associated memory region as shown. Unused memory regions 72, 74, 76 and 78 are interleaved amongst the modules and the kernel memory 71. This is conventional and occurs due to page size alignment considerations. Additionally, as also known, each module begins with a common structure that can be used to pinpoint its precise starting address within a predicted range. Thus, even without relying on the kernel's linked list, these predictable characteristics can be used to generate a trustworthy kernel view of loaded modules. In other words, insertion of any hidden hacker module, such as for example the hacker module surreptitiously inserted between modules 77 and 79 in FIG. 7, results in a determination of an abnormal address range between the end of module 77 and the beginning of module 79 (even accounting for page size alignment considerations).

Recalling premise 2 from above that “memory pages in use indicate a presence of functionality or data” leads to a recognition that the computer's virtual memory can be searched page by page within this predicted range to identify pages that are marked as “active”. Since gaps located between the kernel modules are legitimately caused by page size alignment considerations, there should be no active memory within these pages. However, any active pages within the gaps that contain a module structure indicate the presence of a kernel implant that is loaded and executing, but has been purposefully removed from the module list. Accordingly, the exploitation detection component provides a function 42 for detecting hidden kernel modules, and the flow of its routine (see also FIG. 3, above) is shown in FIG. 8.

Function 42 is initiated via a function call within the loadable kernel module 34 (main c). Its analysis entails a byte-by-byte search for the value of sizeof(struct module) which is used to signal the start of a new module. This space should only be used for memory alignment and the location of data indications that a module is being hidden. During initialization 80, data structures and pointers necessary for the operation of this procedure are created. The starting point for the module listing is located and the read lock for the vmlist is acquired at 81. A loop is then initiated at 82 so that each element (i.e. page of memory) in the vmlist can be parsed. As each element is encountered, a determination is made as to whether the element has the initial look and feel of a kernel module. This is accomplished by ascertaining at 83 whether the element starts with the value sizeof(struct module), as with any valid Linux kernel module. If not, the algorithm continues to the beginning of the loop at 82 to make the same determination with respect to any next module encountered. If, however, the encountered element does appear to have characteristics of a valid kernel module, a pointer is made at 84 to what appears to be a module structure at the top of the memory page. A verification is then made at 85 to determine if pointers of the module structure are valid. If the pointers are not valid, this corresponds to data that is not related to a module and the algorithm continues in the loop to the next element at 82. If, however, the pointers of the module structure are valid then at 86, a determination is made as to whether the module is included in the linked list of modules, as represented by FIGS. 6(a) & (b). If so, then it is not a hidden module, and the function continues in the loop to the next element. However, if the module is not included in the linked list then it is deemed hidden at 86 and results are written to the output file at 87. These results preferably include the name of the module, its size, and the memory range utilized by the module. Optionally, and as discussed in the parent application, appropriate calls can be made via interfaces 18 to appropriate functions associated with a forensics collection module and an OS restoration module. When all the elements in the vmlist have been analyzed, it is unlocked from reading at 88 and the function returns at 89.

It is contemplated by the inventors that the hidden module detection function 42 can be expanded in the future by incorporating the ability to search the kernel for other functions that reference addresses within the gaps that have been associated with a hidden kernel module (indicating what if anything the kernel module has compromised). Such an enhancement would further exemplify how the model can adapt from a positive detection scheme to a negative detection scheme based on sensed need. In essence, the model would still begin by applying a generalized law to the operating system behavior, and detect anomalies in the adherence to this law. When an anomaly is identified, the system could generate or adapt negative detectors to identify other instances of malicious behavior related to this anomaly.

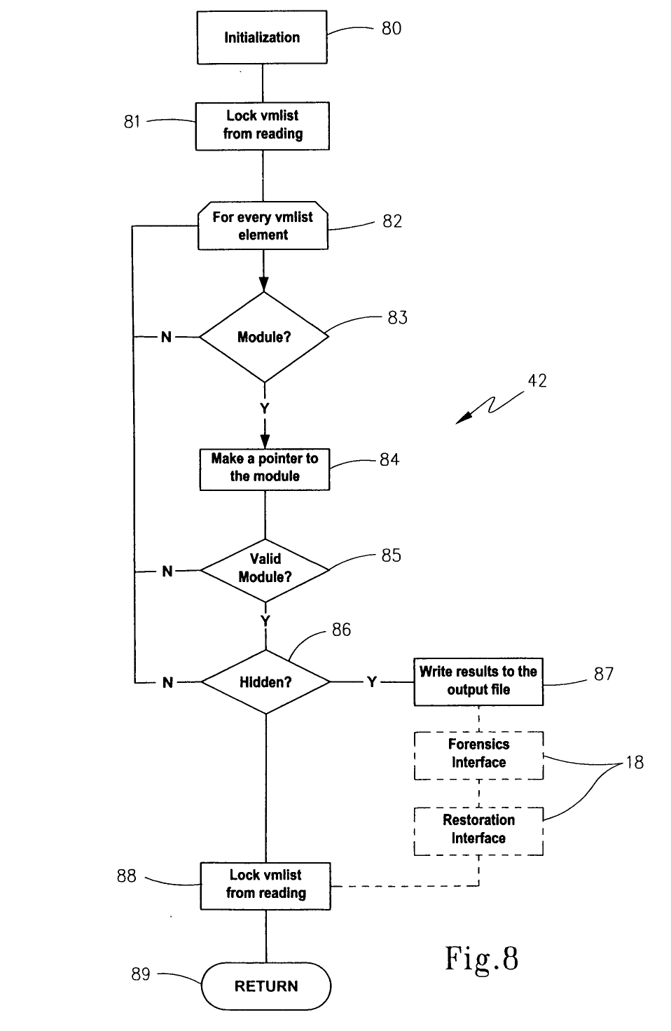

Following hidden module detection, the next function performed by kernel module 34 ascertains the integrity of the system call table by searching the kernel for hidden system call patches. This corresponds to operation 44 in FIG. 4 and is explained in greater detail with reference now to FIGS. 9-11. As represented in FIG. 9, the system call table 90 is composed of an indexed array 92 of addresses that correspond to basic operating system functions. Because of security restrictions implemented by the x86 processor, user space programs are not permitted to directly interact with kernel functions for low level device access. They must instead rely on interfacing with interrupts and most commonly, the system call table, to execute. Thus, when the user space program desires access to these resources in UNIX, such as opening a directory as illustrated in FIG. 9, an interrupt 0x80 is made and the indexed number of the system call table 90 that corresponds to the desired function is placed in a register. The interrupt transfers control from user space 94 to kernel space 96 and the function located at the address indexed by the system call table 90 is executed. System call dependencies within applications can be observed, for example, by executing strace on Linux® or truss on Solaris®.

Most kernel level rootkits operate by replacing the addresses within the system call table to deceive the operating system into redirecting execution to their functions instead of the intended function (i.e., replacing the pointer for sys_open( ) in the example above to rootkit_open( ), or some other name, located elsewhere in memory). The result is a general lack of integrity across the entire operating system since the underlying functions are no longer trustworthy.

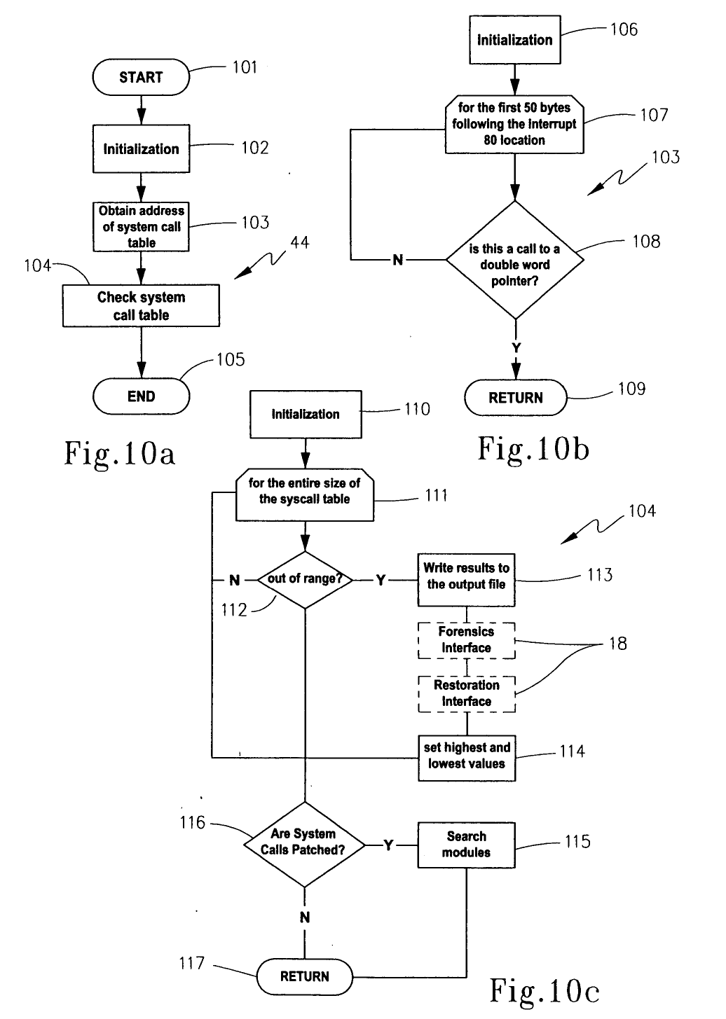

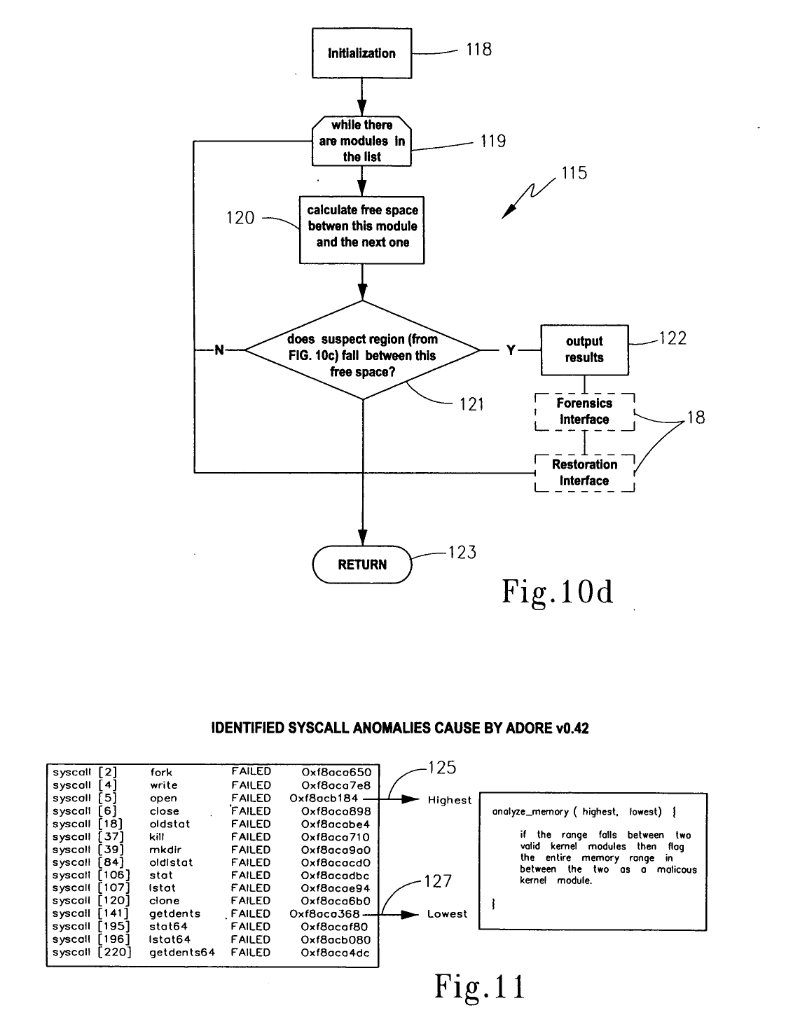

To explain detection of these anomalies in the system call table, reference is made to FIGS. 10(a)-10(d) which together comprise the operation of function 44. Following start 101 and initialization 102, function 44 calls a subroutine 103 to derive a non-biased address of the system call table. Upon return, the system call table is checked via subroutine 104, after which function 44 ends at 105. Subroutine 103 (FIG. 10b) pattern matches for a CALL address following an interrupt 0x80 request. This is necessary to ensure that the addresses retrieved from the system call table are authentic, and are not based on a mirror image of the system call table maliciously created by an intruder. This function is based on a publicly available technique, namely that utilized in the rootkit “SuckIT” for pattern matching against the machine code for a “LONG JUMP” in a particular area of memory, wherein the address of the JUMP reveals the system call table; however, other non-public techniques to do this could be developed if desired. Following initialization 106, the subroutine loops at 107 through the first 50 bytes following the interrupt 80 to find a CALL address to a double word pointer. Once found at 108, subroutine 103 returns at 109.

Once this address has been acquired, the function uses generalized positive anomaly detection based on premise 1 which is reproduced below:
Premise 1: All kernel calls should only reference addresses located within normal kernel memory.
   Specifically, on Linux, the starting address of the kernel itself is always located at 0xC0100000. The ending space can be easily determined by the variable _end and the contiguous range in between is the kernel itself. Although the starting address is always the same, the ending address changes for each kernel installation and compilation. On some distributions of Linux this variable is global and can be retrieved by simply creating an external reference to it, but on others it is not exported and must be retrieved by calculating offset based on the global variable _strtok or by pattern matching for other functions that utilize the address of the variable. Once the address range for the kernel is known, subroutine 104, following initialization 110, searches the entire size of the syscall table at 111. With respect to each entry, a determination 112 is made as to whether it points to an address outside the known range. If so, results are written to the output file at 113 whereby the name of the flagged system call may be displayed, along with the address that it has been redirected to. Again, although not required by the present invention, optional calls can be made to forensics and restoration modules through interfaces 18. A high and low recordation is maintained and updated for each out of range system call address encountered at 114. Thus, following complete analysis of the table and based on the final highest and lowest address values, the system has determined an estimated memory range of the module responsible for patching the system call table. This range is identified as a malicious kernel rootkit.

Thus, if addresses within the system call table have been patched at 116, another subroutine 115 (FIG. 10d) is called to search the memory within the highest and lowest addresses for patched system calls. Because the highest and lowest addresses refer to a range of memory that contains the functions of the hidden module, it is utilized as a second method of module detection. Following its initialization at 118, subroutine 115 begins to loop at 119 through each module in the list. A calculation is made at 120 to determine the free space between the encountered module and the next module in the list. If the suspect region between the highest and lowest value determined by subroutine 104 (FIG. 10c) falls within this free space, results are preferably output at 122. Rather than only outputting the range of memory between the highest and lowest value, the entire range within the two modules is outputted. For example, if the highest address is 17 and the lowest address is 12, but Module A stops at 10 and Module B starts at 20 then the range 10-20 is reported to encompass all possible memory related to the functionality. Once subroutine 115 returns at 123, or if the lowest has not been set at 116 (FIG. 10c), then subroutine 117 also then returns.

FIG. 11 illustrates, for representative purposes, an example when the function 44 for searching hidden system call table patches is executed against a kernel which has been exploited by the Adore v0.42 rootkit. This figure identifies system calls that have been identified as patched (i.e., “FAILED”) as well as the address that the calls have been assigned to. As described above, a variable is used to store the highest and the lowest values of these addresses 125 and 127, respectively. These values correlate a range of memory pointed to by the patched system calls and is used as a second technique for hidden module detection.

The above function 44 will, thus, identify any rootkit that dynamically patches into the system call table of a running kernel. Because this model is based on a fundamental law (premise 1), no false positives will occur. Any unknown change of system call table addresses into non-normal kernel memory, thus, indicates a kernel rootkit. This model, however, does err on the conservative side and will not detect changes in addresses that are physically located within the kernel memory itself. To accomplish this, a rootkit designer would need to insert functions directly over existing kernel functions that are used only on startup or are used infrequently. This is perhaps more theoretical than practical, and the inventors are unaware that if has ever been implemented in a publicly released rootkit. Notwithstanding, the solution to detecting such an occurrence using a conservative approach is again similar to that of the biological immune system; additional sensors can be introduced for redundancy. For instance, based on the same premise 1, the model could be expanded to cover general functional integrity verification as well. For example, beginning with the system call table integrity verification model discussed above, one could check for addresses within the system call table that fall outside of the “boot” range. If all addresses are found to be within the valid range, another function could be called to trace the pointers to the level whereby the verification process is repeated. Eventually, the execution paths will be exhausted and either all functions will be located within the appropriate address range, or an anomaly will be encountered. In addition to this capability, page tables could also be analyzed to identify anomalous behavior that violates the notion that the kernel should not be calling outside areas of memory.

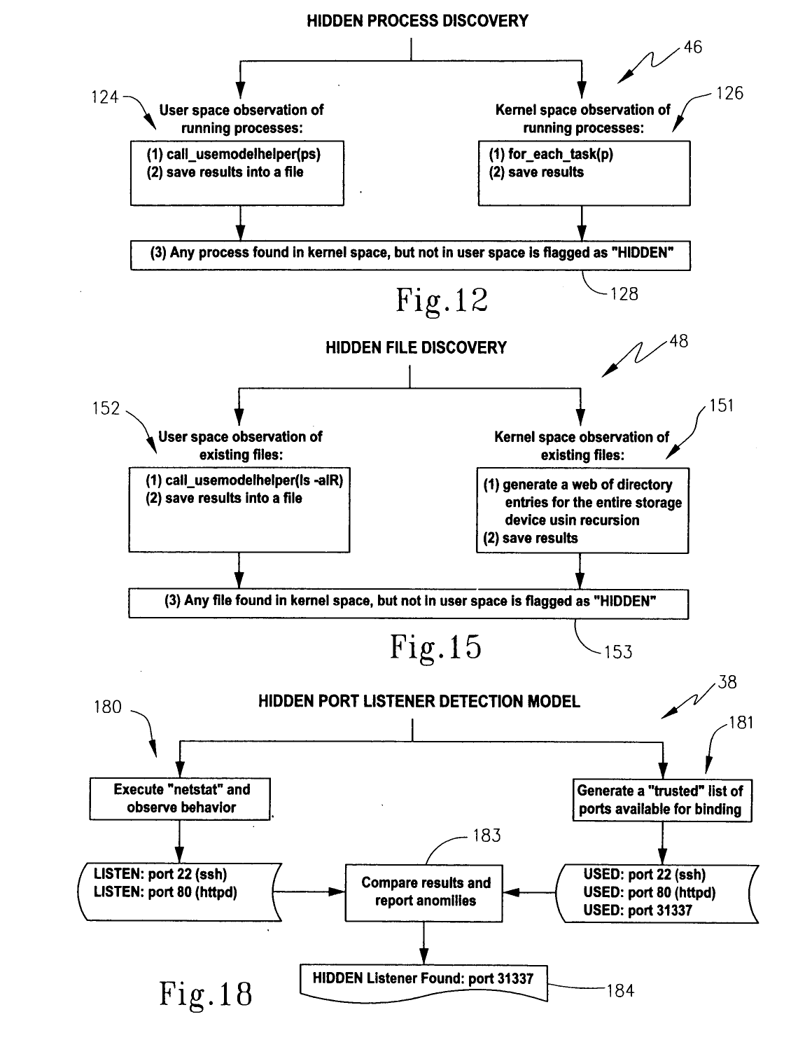

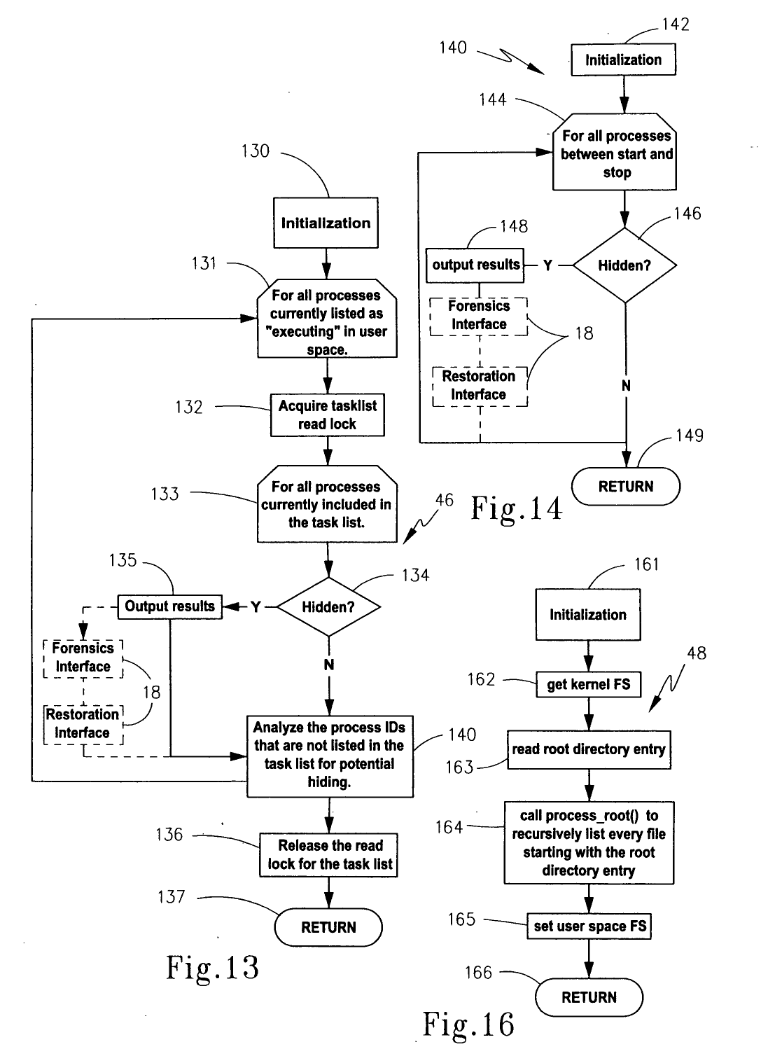

The hidden process detection function 46 (FIG. 4) is capable of identifying running processes that are hidden by either user space or kernel space rootkits. This is diagrammatically depicted in FIG. 12, and an exemplary algorithmic flow for the function is illustrated in FIG. 13. The hidden process detection model employs two different sensors. The first sensor is based on premise 3 from above that “A process visible in kernel space should be visible in user space.” This sensor executes a ps command to observe an untrusted user space view 120 (FIG. 12) of the running processes. Following this, it manually walks each element in the task structure to generate a trusted list 122 of running processes from the kernel's view. The two views are then compared at 124 and anomalies are identified which indicate that a process is hidden.

This sensor can discover process hiding techniques that rely on the notion of “PID 0 hiding” which was introduced by Adore on Linux. It can also detect hiding done by system calls, and hiding done by user space rootkits or Trojans. By default, processes with a PID of zero are not displayed by any of the systems administration utilities; therefore, simply renumbering the PID can be used to easily hide a process. The downside is that the standard exit( ) function does not operate properly with a PID of zero, so the attacker must trap all exits made by the hidden process and replace the PID to a valid number prior to exiting.

With reference to FIG. 13, the hidden process detection function 46 initializes at 130 to prepare necessary data structures, output file reports, and any user space listing of processes that are currently executing. It then performs a loop at 131 while reading in a buffer which contains a listing of all processes currently executing in user space. The read lock for the task list is acquired at 132. Another loop is initiated at 133 to analyze each element within the task list, wherein each element represents a process scheduled for execution. If the process is in the task list, but not in the user space buffer then it is deemed hidden at 134 and reported as such at 135. At this point, another procedure can be called to look for more sophisticated process hiding techniques. This subroutine 140 (described below) will detect processes that have been completely removed from the task list. When subroutine 140 completes, the loop returns to process any other elements in the buffer. Otherwise, the read lock for the task list is released at 137 and control is returned to the calling kernel module 34.

Although the hidden process detection model does not produce any false positives, current implementation theoretically suffers from a potential race condition that may result in innocent processes being reported. For instance, if a process exits or is created during the instance between the user and kernel space observations then an incorrect anomaly may be reported for that process. This can be corrected with additional time accounting and/or temporary task queue locking to ensure that only process changes started or stopped before a particular instance are observed. As with other detection models associated with the exploitation detection component of the invention, this model errors on the conservative side and relies on redundancy. For instance, this particular sensor is capable of detecting most hiding techniques, but it relies on the presence of the process within the kernel task queue. Although not tremendously stable, it has been demonstrated through implementation in Adore that a process can be run without being present in the task queue once it has been scheduled. To detect this hiding technique, a second negative sensor is deployed to investigate the presence of anomalies within process IDs that are not present within the task queue.

Subroutine 140 associated with the hidden process detection function 46 is diagrammed FIG. 14. This sensor is based on the premise 2 from above that “Memory pages in use indicate the presence of functionality or data.” Process file system entries are specifically searched one by one to identify the presence of a process in memory within the gap. This detects all process hiding techniques that operate by removing the process from the task queue for scheduling. Following initialization 142, where necessary data structures and report output files are prepared, procedure 140 begins to loop at 144 through each address between “start” and “stop”. Start and stop in this case get passed in by the calling procedure 46 (FIG. 13) and refers to the process IDs that are missing from the last two numbers found within the task list. For example, if the IDs 100 and 123 are linked to each other then “start” is 101 and “stop” is 122. By looking for the presence of /proc/PID/cmdline for each process ID that falls in this gap range, processes can be identified at 146 that have been hidden by being removed from the task list. If the cmdline file exists, then this is a valid process that has been hidden and information about it can be output into a results file at 148. Optional forensics and restoration functions can be called at this point via interfaces 18. On the other hand, if the cmdline file is not present at 146, then it is not a valid process and the loop is either continues at 144 to the next PID or control is returned at 149 to hidden process detection function 46 in FIG. 13.

Subroutine 140 might also suffer from the same potential race condition as the function 46 discussed above, since a process that is created or has existed between the observation of the task queue and the observation of the /proc file system could theoretically report a false anomaly. Note that like the earlier sensor, this false positive is due to an implementation based race condition and not an error in the premises or overall model. Accordingly, this implementation can also be enhanced by incorporating timing mechanisms and task queue locks to prevent the occurrence of such race conditions.

It is the intent of the inventors in the future to develop additional sensors to strengthen exploitation detection component by incorporating further redundancy. For instance, premise 2 can also be used as a basis for creating a sensor which generically searches through all kernel page tables for ELF (Executable and Linking Format) headers. These headers can be compared against those of visible processes, with any discrepancies indicating a hidden process. Regardless of the particular hiding technique employed, the rootkit cannot escape the fundamental law that the process must be located in memory to operate.

The terminal function associated with kernel module 34 (FIG. 3) is the hidden file detection function 48. This is described in the functional block diagram of FIG. 15 and the flow diagram of FIG. 16. Hidden files are perhaps the most difficult aspect of a rootkit to successfully detect. Implementation is difficult because there are potentially hundreds of different hiding techniques, file systems do not always “remove” data from the media when a file is deleted, and the increasing storage sizes of media make for a tremendously time consuming search. However, as with the other detection schemes described herein, the strength in the model depends on redundancy. The hidden file detection model is based on premise 5 from above that “Persistent files must be present on the file system media” because no hiding technique can maintain persistent files without storing them somewhere on media. Some techniques employ memory buffers that flush data out to disk only when a reboot is sensed. Since not all systems are cleanly shutdown, this does not represent true persistence. An unexpected power failure will shut the computer down without flushing the hidden file to disk. However, for completeness, it is intended that future implementations of the model will incorporate a sensor based on the second premise that “memory pages indicate the presence of functionality or data” to detect files located only in memory.

The hidden file detection function 48 operates by first observing a kernel space view 151 of visible files which are deemed “trusted” (FIG. 15). Each listing is then searched for in user space 152 to determine if there is a correspondence between them. Based on the results obtain, a determination 153 can be made whether the file is hidden or not. The kernel portion of the implementation can be appreciated with reference to FIG. 16. As with other routines, upon initialization 161, hidden file detection function 48 prepares necessary data structures and report output files. At 162, the original file system setting is saved and the current settings are changed to kernel space. The root directory entry is then opened and read at 163. The subroutine process_root( ), which is based on an open source function within the Linux kernel, is then called at 164 to generate a complete recursive listing of all files and directories that fall within the root directory. The results are printed to the file descriptor discussed above with reference to the kernel module's initialization 41. In addition to the filename, the inode and file size are also printed. At 165, the file system is then set back to the original user setting that was saved at 162, and control returns at 166.

As with hidden process detection, the current implementation of the hidden file detection model could potentially suffer from race conditions that result in false positives if files are removed during the instance between user space and kernel space analysis. This is a limitation in implementation and not the model itself, and can be solved by incorporating timing and/or temporary file system locking mechanisms. For speed, the current model conducts searches based in cached entries. In the future, more robust searching techniques could be devised and implemented. In addition, enhanced negative detection sensors could be created and deployed to specifically search in areas that are known to store other malicious data, such as the previously detected hidden process, kernel module, or files currently opened by them.

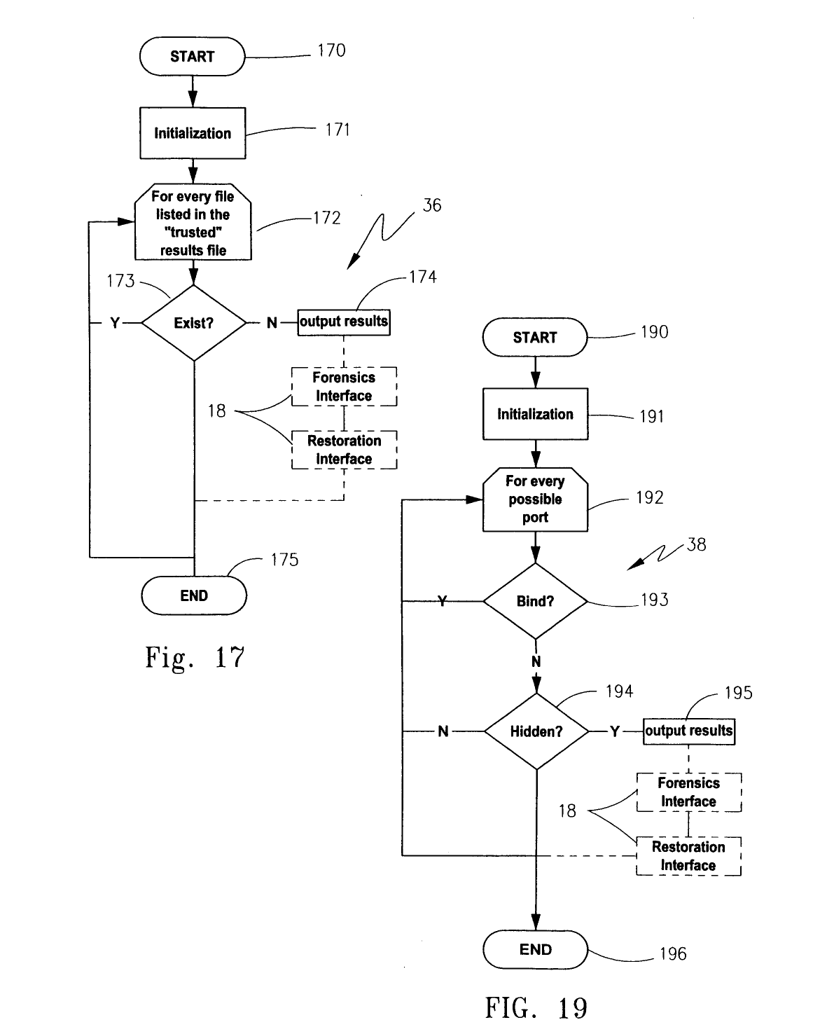

Returning now to the exploitation detection component diagram of FIG. 3, it is recalled that the file checker script 36 is executed upon completion of kernel module 34. FIG. 17 shows the program flow for this script. Upon starting at 170, the necessary variables are initialized at 171 and the “trusted” file listing generated by kernel module 34 (FIGS. 15 & 16) is opened for reading. A loop is initiated at 172 to analyze each file in the “trusted” file listing. If the file exists at 173 (i.e. if it is visible) in user space from this script, then the loop returns to analyze the next file in the listing. If the file is not visible then it is reported as hidden and the name is stored in the results file at 174. Once the recursive looping 172 is completed, the script ends at 175.

The port checker script 38 (FIG. 3) is then initiated. This script is outlined in FIGS. 18 & 19. Port checker script 38 is similar to the hidden process detection function discussed above because it operates by observing both a trusted and untrusted view of operating system behavior. This model is based on premise 4 from above that “All unused ports can be bound to.” With initial reference to FIG. 18, the untrusted view 180 is generated by executing netstat, and the trusted view 181 is accomplished by executing a simple function that attempts to “bind” to each port available on the computer. These views are compared 183 to identify at 184 any hidden listeners. FIG. 19 illustrates the routine for implementing this functionality. Once launched at 190, it too initializes at 191 to establish necessary variables and generate an “untrusted” user space view utilizing netstat results. A loop is then started at 192 for every possible port on the computer system (approximately 35,000). If the port checker is able to bind to the encountered port at 193, this means that there is no listener installed, so the script progresses to the next port in the loop at 192. If the encountered port cannot be bound to, then a determination is made as to whether the port is listed in the “untrusted” netstat listing. If the port is listed in the “untrusted” user space listing of ports according to netstat, then at 194 it is deemed not hidden so we progress to the next port in the loop. If the encountered port is not listed, this corresponds to it being hidden so its name is saved in the results file at 195. As discussed in the parent application, if the exploitation detection component is not operating independently, appropriate forensics and restoration functions could be called at this point via interfaces 18, as with earlier procedures. Once all ports have been tested, port checker script 38 terminates at 196.

It is believed that, in order for a port listener to defeat this function, it must erroneously redirect all bind attempts to the hidden port. The redirection would either have to return a false “positive” that the bind attempt was successful, or would have to redirect the bind to a different port. Both behaviors noticeably alter the behavior of the operating system and are ineffective methods of hiding. For instance, if this system were expanded to actually conduct a small client server authentication test in addition to the bind, then it would discover that the listener present on the port does not match the anticipated “self” behavior. Nonetheless, it is envisioned that future implementations could incorporate such tests for just that purpose. Additional sensors could also be created to collect raw TCP/IP traffic behavior from within the kernel itself to further expand detection to non port bound listeners.

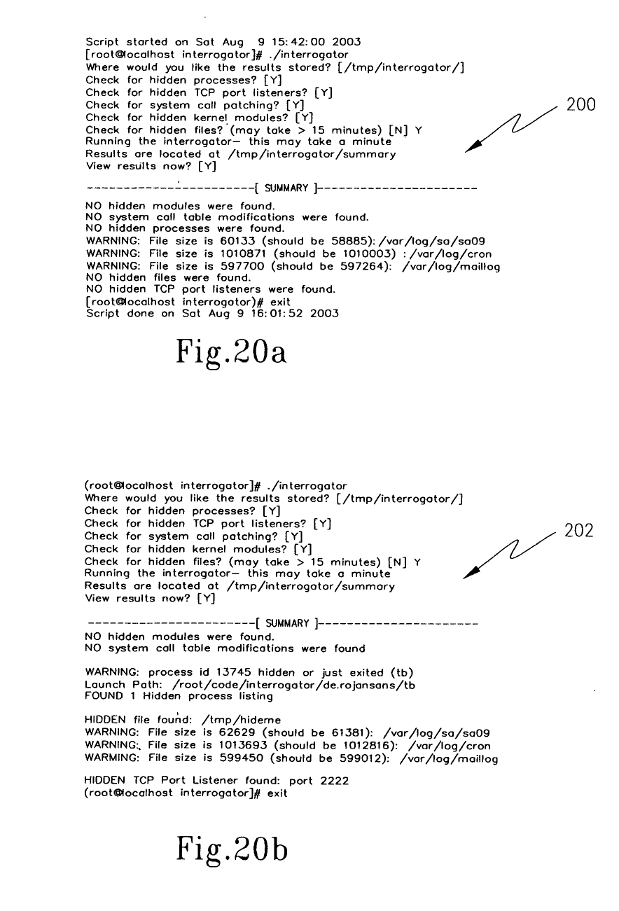

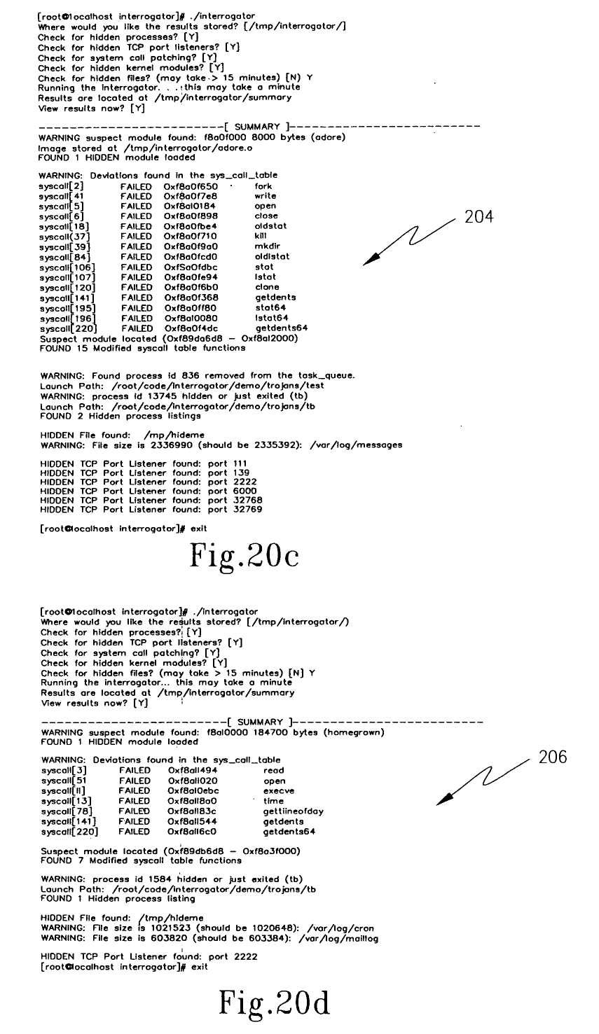

Having described in detail in FIGS. 3-19 the exploitation detection component 12 of the invention, reference is now made to FIGS. 20(a)-(d) to illustrate representative test results obtained with the detection component. The results shown demonstrate that this component is tremendously effective at detecting operating system compromises involving rootkits and backdoors. Tests were conducted on a computer with a standard installation of the Linux 2.4.18-14 operating system. The actual execution of the exploitation detection component (not including hidden file detection 48) can take less then one minute to complete. However, when hidden file searching is incorporated, the execution time can dramatically increase (approximately 15 minutes for a 60 GB hard drive). Two types of tests were initially conducted: (1) executing with and (2) executing without searching for hidden files. However, results from hidden process detection 46, port checker 38, system call patching 44, and hidden module detection 42 were identical in both types of tests so subsequent tests only involved searching for hidden files.

FIG. 20(a) shows results 200 reported when the system was executed against a clean system. In this case no hidden modules, system calls, processes, files, or port listeners were reported. The only reported anomaly is listed at 202 only as a “WARNING” that file sizes increased for three of the system logs during the execution.

FIG. 20(b) shows results 202 that were reported when the exploitation detection component 12 was executed against a system with user space Trojans of ps, ls, and netstat. As can be seen in this figure, the user space Trojans were designed to hide the process ID 13745, the file /tmp/hideme, and a TCP port listener located on port 2222. As can be seen, all were successfully detected.

Two different kernel space rootkits were also tested, with results shown in FIGS. 20(c)&(d), respectively. The first was Adore version 0.42. This is one of the most popular and advanced rootkits publicly available. In addition to standard system call based process hiding it also includes the capability to remove process from the task queue as discussed earlier. Results 204 obtained when the exploitation detection component was tested against Adore are shown in FIG. 20(c). In this case, it may be seen that Adore was configured to hide process ID 13745 using standard system call hiding techniques and to physically remove process ID 836 from the task queue. Both were easily detected by the exploitation detection component. In addition, even though the module was physically removed from the module listing it is quickly identified. All 15 system calls Adore patched were discovered. The file /tmp/hideme that was hidden was discovered, and the only other disk warning was that /var/log/messages increased slightly in size. The port hidden by Adore was 2222, which was discovered. However, because the implementation of Adore physically breaks netstat's ability to output to a pipe, there is no “untrusted” view to compare against. Therefore all bound ports are reported whether malicious or not.

The second kernel rootkit test was conducted against a homegrown rootkit that does not match the signature of anything currently known. Therefore, as explained in the Background section, such a rootkit cannot be detected by Chkrootkit or others that are signature based. The results 206 of the exploitation detection component on the homegrown rootkit are illustrated in FIG. 20(d). As with the previous kernel level rootkit test, the module itself is discovered. All seven of the patched system calls were discovered. The process hiding technique is based on system call patching, and the hidden process ID 1584 was detected as in the other examples. The hidden file /tmp/hideme was detected and two warnings were issued because of sizes increases in log messages. The hidden TCP listener on port 2222 was also detected. Because this rootkit does not physically break netstat like Adore, no additional false positive port listeners were listed.

Due to the demonstrated success of this exploit detection model it is contemplated, as discussed above, that the current system can be expanded to include additional sensors based on the previously discussed five premises/laws. One particular enhancement could be the implementation of a redundancy decision table that is based on the same derived premises and immunology model discussed herein. That is, rather than relying on a single sensor model for each area of concern, hybrid sensors could be deployed for each level of action related to the focal area. The following chain of events are exemplary of what might occur to detect a hidden process:
1. A user space “ls” is performed
2. The getdents system call is made
   The results of actions 1 and 2 are compared, and any anomalies between the two indicate that the “ls” binary has been physically trojaned by a user space rootkit.
3. The sys_getdentsO function is called from the kernel
   Any anomalies between 2 and 3 indicate that the system call table has been patched over by a kernel rootkit. The kernel will then be searched for other occurrences of addresses associated with the patched function to determine the extent of infection caused by the rootkit.
4. The vfs_readdir( ) function is called from the kernel
   Any anomalies between 3 and 4 indicate that the function sys_getdents( ) has been physically patched over using complex machine code patching using a kernel rootkit. Although this patching technique has not known to have been publicly implemented, it is theoretically possible and therefore requires defensive detection measures.
5. Raw kernel file system reads are made
   Any anomalies between 4 and 5 indicate that vfs_readdiro or a lower level function has been patched over by a complex kernel rootkit.
6. Raw device reads are made
   Any differences between 5 and 6 indicate that a complex hiding scheme that does not rely on the file system drivers of the executing operating system has been implemented. The same series of decision trees can be built for the flow of execution of all system calls.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A system for detecting an operating system exploitation which is of a type that renders a computer insecure, said system comprising:
(a) a storage device;
(b) an output device; and
(c) a processor programmed to:
(1) monitor the operating system to ascertain an occurrence of anomalous activity resulting from operating system behavior which deviates from any one of a set of pre-determined operating system parameters, wherein each of said pre-determined operating system parameters corresponds to a dynamic characteristic associated with an unexploited said operating system; and
(2) generate output on said output device which is indicative of any said anomalous activity that is ascertained.

2. A system according to claim 1 wherein the set of pre-determined operating system parameters is selected from:
(1) a first parameter corresponding to a requirement that all calls within the system call table associated with the operating system's kernel reference an address that is within the kernel's memory range;
(2) a second parameter corresponding to a requirement that each address range between adjacent modules in a linked list of modules be devoid of any active memory pages;
(3) a third parameter corresponding to a requirement that a kernel space view of each running process correspond to a user space view of each running process;
(4) a fourth parameter corresponding to a requirement that there be a capability to bind to any unused port on the computer; and
(5) a fifth parameter corresponding to a requirement that a kernel space view of each existing file correspond to a user space view of each existing file.

3. A system according to claim 2 wherein the operating system is Unix-based and the kernel memory range is between a starting address of 0xc0100000 and an ending address as determined with reference to one of a global variable and an offset calculation based on said global variable.

4. A system according to claim 1 wherein said processor is programmed to ascertain an occurrence of anomalous activity upon detecting any one of:
(a) a call within a system call table associated with the operating system's kernel which references a memory address outside of the kernel's memory range;
(b) an active memory page located within an address range between a pair of linked kernel modules, wherein said active memory page contains a module structure;
(c) a lack of correspondence between a kernel space view of each running process and a user space view of each running process;
(d) an inability to bind to an unused port on the computer; and
(e) a lack of correspondence between a kernel space view of each existing file and a user space view of each existing file.

5. A system according to claim 1 wherein said exploitation is selected from a group of comprises consisting of a hidden kernel module, a hidden system call table patch, a hidden process, a hidden file and a hidden port listener.

6. A system for detecting an operating system exploitation which is of a type that renders a computer insecure, said system comprising:
(a) storage means;
(b) output means;
(c) processing means for:
(1) monitoring the operating system to ascertain an occurrence of any anomalous activity resulting from behavior which deviates from any one of a set of pre-determined operating system parameters, wherein each of said pre-determined operating system parameters corresponds to a dynamic characteristic associated with an unexploited said operating system; and
(2) generating output on said output means which is indicative of any anomalous activity that is ascertained.

7. A computerized method for detecting exploitation of a computer operating system, comprising:
(a) establishing a set of operating system parameters, each corresponding to a dynamic characteristic associated with an unexploited operating system;
(b) monitoring the operating system to ascertain an occurrence of any anomalous activity resulting from behavior which deviates from any one of the set of operating system parameters; and
(c) generating output indicative of a detected exploitation upon ascertaining said anomalous activity.

8. A computerized method according to claim 7 wherein the set of operating system parameters is selected from a group consisting of:
(1) a first parameter corresponding to a requirement that all calls within the system call table associated with the operating system's kernel reference an address that is within the kernel's memory range;
(2) a second parameter corresponding to a requirement that each address range between adjacent modules in a linked list of modules be devoid of any active memory pages;
(3) a third parameter corresponding to a requirement that a kernel space view of each running process correspond to a user space view of each running process;
(4) a fourth parameter corresponding to a requirement that there be a capability to bind to any unused port on the computer; and
(5) a fifth parameter corresponding to a requirement that a kernel space view of each existing file correspond to a user space view of each existing file.

9. A computerized method according to claim 7 whereby a deviation is deemed to exist upon ascertaining any one of:
(a) a call within a system call table associated with the operating system's kernel which references a memory address outside of the kernel's memory range;
(b) an active memory page located within an address range between a pair of linked kernel modules, wherein said active memory page contains a module structure;
(c) a lack of correspondence between a kernel space view of each running process and a user space view of each running process;
(d) an inability to bind to an unused port on the computer; and
(e) a lack of correspondence between a kernel space view of each existing file and a user space view of each existing file.

10. A computerized method according to claim 7 wherein said exploitation is selected from a group of comprises consisting of a hidden kernel module, a hidden system call table patch, a hidden process, a hidden file and a hidden port listener.

11. A computerized method for detecting exploitation of a selected type of operating system, wherein the exploitation is one which renders a computer insecure, and whereby said method is capable of detecting said exploitation irrespective of whether the exploitation is signature-based and without a prior baseline view of the operating system, said method comprising:
monitoring the operating system to ascertain an occurrence of any anomalous activity resulting from behavior which deviates from any one of a set of operating system parameters, each operating system parameter corresponding to a dynamic characteristic associated with an unexploited operating system of the selected type.

12. A computerized method according to claim 11 whereby a deviation is deemed to exist upon ascertaining any one of:
(a) a call within a system call table associated with the operating system's kernel which references a memory address outside of the kernel's memory range;
(b) an active memory page located within an address range between a pair of linked kernel modules, wherein said active memory page contains a module structure;
(c) a lack of correspondence between a kernel space view of each running process and a user space view of each running process;
(d) an inability to bind to an unused port on the computer; and
(e) a lack of correspondence between a kernel space view of each existing file and a user space view of each existing file.

13. A computerized method according to claim 11 wherein said exploitation is selected from a group of comprises consisting of a hidden kernel module, a hidden system call table patch, a hidden process, a hidden file and a hidden port listener.

14. A computer-readable medium for use in detecting rootkit installations on a computer running an operating system, said computer-readable medium comprising a loadable kernel module having executable instructions for performing a method comprising:
monitoring the operating system to ascertain an occurrence of any anomalous activity resulting from behavior which deviates from any one of a set of dynamic operating system parameters, each operating system parameter corresponding to a dynamic characteristic associated with an unexploited operating system of the selected type.

15. A computer-readable medium according to claim 14 wherein the set of operating system parameters is selected from a group consisting of:
(1) a first parameter corresponding to a requirement that all calls within the system call table associated with the operating system's kernel reference an address that is within the kernel's memory range;
(2) a second parameter corresponding to a requirement that each address range between adjacent modules in a linked list of modules be devoid of any active memory pages;
(3) a third parameter corresponding to a requirement that a kernel space view of each running process correspond to a user space view of each running process;
(4) a fourth parameter corresponding to a requirement that there be a capability to bind to any unused port on the computer; and
(5) a fifth parameter corresponding to a requirement that a kernel space view of each existing file correspond to a user space view of each existing file.

16. A computer-readable medium according to claim 15 wherein said executable instructions are operative to ascertain a deviation upon occurrence of any one of:
(a) a call within a system call table associated with the operating system's kernel which references a memory address outside of the kernel's memory range;
(b) an active memory page located within an address range between a pair of linked kernel modules, wherein said active memory page contains a module structure;
(c) a lack of correspondence between a kernel space view of each running process and a user space view of each running process;
(d) an inability to bind to an unused port on the computer; and
(e) a lack of correspondence between a kernel space view of each existing file and a user space view of each existing file.

17. A computer-readable medium for use in detecting a rootkit exploitation of a computer running a Linux operating system, wherein said rootkit exploitation is of a type that renders the computer insecure, said computer-readable medium comprising:
(a) a loadable kernel module having executable instructions for performing a method comprising:
analyzing the operating system's memory to detect an existence of any hidden kernel module;
analyzing the operating system's system call table to detect an existence for any hidden patch thereto;
analyzing the computer to detect an existence of any hidden process; and
analyzing the computer to detect an existence of any hidden file.

18. A computer-readable medium according to claim 17 wherein said executable instructions are operative to analyze the computer for any hidden process by generating respective kernel space and user space views of running processes on the computer and ascertaining if a discrepancy exists therebetween.

19. A computer-readable medium according to claim 17 wherein said executable instructions are operative to analyze the computer for any hidden file by generating respective kernel space and user space views of existing files on the computer and ascertaining if a discrepancy exists therebetween.

20. A computer-readable medium according to claim 17 wherein said executable instructions are operative to analyze the system call table by initially obtaining an unbiased address for the system call table, and thereafter searching each call within the system call table to ascertain if it references an address outside of a dynamic memory range for the operating system's kernel.

21. A computer-readable medium according to claim 17 wherein said executable instructions are operative to display characteristic output results for any hidden kernel module, hidden system call table patch, hidden process and hidden file which is detected.
